(19) United States
(12) Patent Application Publication
(10) Pub. No.: US 2018/0198167 A1
(43) Pub. Date: Jul. 12, 2018

(54) IONIC LIQUID ELECTROLYTES AND ELECTROCHEMICAL DEVICES COMPRISING SAME

(71) Applicant: The Trustees of Boston University, Boston, MA (US)

(72) Inventors: Mark W. Grinstaff, Brookline, MA (US); Xinrong Lin, Boston, MA (US)

(21) Appl. No.: 15/744,003

(22) PCT Filed: Jul. 15, 2016
(86) PCT No.: PCT/US16/42526

§ 371 Date: Jan. 11, 2018

Related U.S. Application Data
(60) Provisional application No. 62/192,868, filed on Jul. 15, 2015.

(51) Int. Cl. H01M 10/0568; H01G 11/62; H01G 11/06; H01M 10/0525; H01M 10/0569

(52) U.S. Cl. CPC H01M 10/0568; H01G 11/62; H01M 2300/0045; H01M 10/0525; H01M 10/0569; H01G 11/06

(57) ABSTRACT

The present disclosure provides novel ionic liquids with favorable thermal and electrochemical properties. Also provided are devices incorporating the ionic liquids, such as Lithium-ion batteries and supercapacitors.

### REFERENCE TO RELATED APPLICATION

This application claims the benefit of priority to U.S. Provisional Application No. 62/192,868, filed on Jul. 15, 2015. The entire teachings of that application are incorporated herein by reference.

### BACKGROUND OF THE INVENTION

The generation, storage and use of sustainable electrochemical energy have become key needs for continued global economic growth. Energy storage devices such as rechargeable Li/Li-ion battery are well suited to address these needs because of their high energy and power densities. While efforts have continuously been made to develop better electrode materials and the electrolytes, a major challenge that remains in these devices is their safety and operation at temperatures above 25° C. Commonly used electrolytes are flammable and low-boiling point organic solvents such as ethylene carbonate (EC) and dimethyl carbonate (DMC), the evaporation and ignition of which are detrimental to the system stability. This can result in fire or explosions. This limitation also reduces the application space for Li ion batteries, and thus there is a need for Li ion batteries that can perform in more demanding conditions such as those found in automotive, aeronautic, oil exploration, and mining applications, to name just a few.

Ionic liquids are salt-like materials bonded through ionic interactions, which have melting points below about 100° C. They are non-flammable room temperature molten salts that possess essentially zero vapor pressure and a wide electrochemical window. As such, these materials are of interest as electrolytes for Li/Li-ion batteries and other devices.

Conventional ionic liquids are composed of one organic cation, such as an imidazolium, pyridinium, pyrrolidinium, phosphonium, ammonium, or sulfonium; and one inorganic or organic anion, such as hexafluorophosphate, tetrafluoroborate, halide, alkyl sulfate, methansulfonate, tosylate, or carboxylic acid. These ionic liquids always contain a mono-cation, paired with a singly-charged counter anion. A typical example is 1-ethyl-3-methylimidazolium tetrafluoroborate, which is also the first air- and water-stable ionic liquid synthesized by Wilkes in 1992.

More recently, some new dicationic ionic liquids and even tricationic ionic liquids with corresponding number of mono-anions have been reported, which possess interesting physicochemical properties compared with those traditional ones. The wide range of possible cation and anion combinations allows for a variety of tunable structures and properties.

### SUMMARY OF THE INVENTION

An aspect of the invention is an ionic liquid electrolyte, comprising a cation represented by

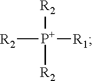

a counter anion; and

a lithium salt;

wherein independently for each occurrence

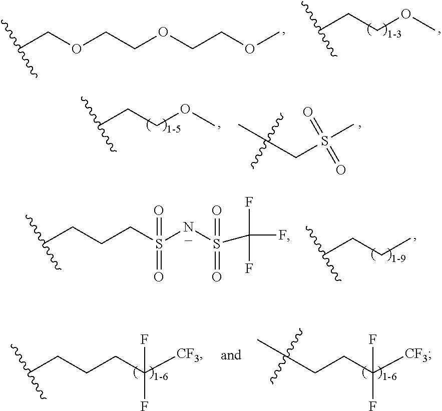

R₁ is selected from the group consisting of

R₂ is selected from the group consisting of

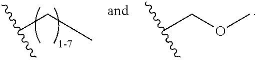

In certain embodiments, R₁ or at least one instance of R₂ is an ether, a sulfoxide, or a sulfonimide.

In certain embodiments, R₁ or at least one instance of R₂ is an ether.

In certain embodiments, the R₂'s are identical.

In certain embodiments, the R₂'s are identical ethers.

In certain embodiments, the R₂'s are not identical.

An aspect of the invention is an ionic liquid electrolyte, comprising a cation represented by

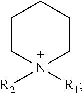

a counter anion; and

a lithium salt;

wherein independently for each occurrence

R₁ is selected from the group consisting of

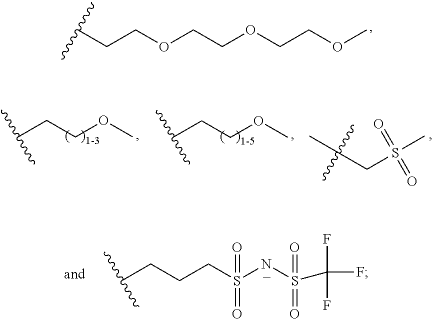

and

R₂ is

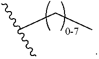

An aspect of the invention is a an ionic liquid electrolyte, comprising a cation represented by

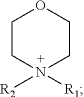

a counter anion; and

a lithium salt;

wherein independently for each occurrence

R₁ is selected from the group consisting of

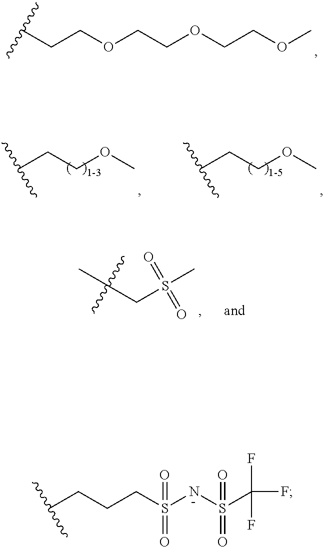

and

R₂ is

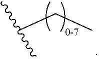

In certain embodiments, the counter anion is selected from the group consisting of PF₆⁻, AsF₆⁻, CF₃SO₃⁻, TFSI⁻ (bis(trifluoromethane)sulfonimide [TFSI]), BF₄⁻, ClO₄⁻, and BOB⁻ (bis(oxalate)borate).

In certain embodiments, the lithium salt is selected from the group consisting of LiPF₆, LiAsF₆, LiCF₃SO₃, LiTFSI, LiBF₄, LiClO₄, and LiBOB.

An aspect of the invention is a Li ion battery, comprising an anode, a cathode, a separator, and an ionic liquid electrolyte of the invention, where the Li salt is present at a concentration of at least 1.0 M.

In certain embodiments, the battery performs at temperatures greater than or equal to about 100° C.

In certain embodiments, the battery performs both at temperatures greater than or equal to about 90° C. and at temperatures less than or equal to about 25° C. An aspect of the invention is a supercapacitor comprising an ionic liquid electrolyte of the invention, where the Li salt is present at a concentration of at least 1.0 M.

In certain embodiments, the supercapacitor performs at temperatures greater than or equal to about 100° C.

In certain embodiments, the supercapacitor performs both at temperatures greater than or equal to about 90° C. and at temperatures less than or equal to about 25° C.

An aspect of the invention is an ionic liquid, comprising a cation selected from the group consisting of

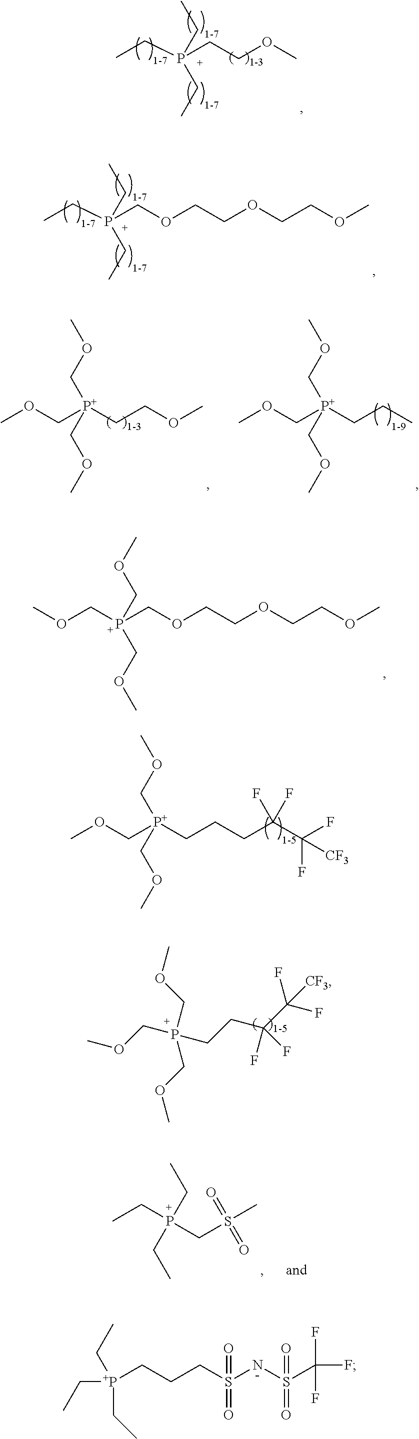

and a counter anion.

An aspect of the invention is an ionic liquid, comprising a cation selected from the group consisting of

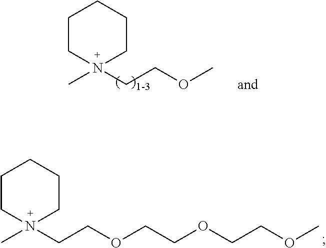

and a counter anion.

In certain embodiments, the cation is

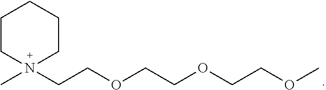

An aspect of the invention is an anionic liquid, comprising a cation selected from the group consisting of

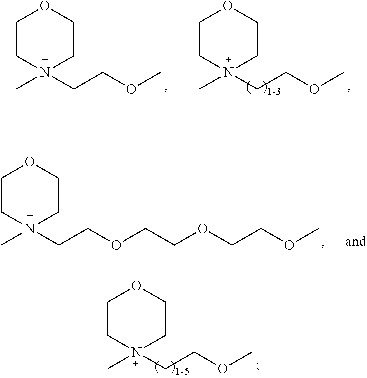

and a counter anion.

In certain embodiments, the counter anion is selected from the group consisting of PF₆⁻, AsF₆⁻, CF₃SO₃⁻, TFSI⁻ (bis(trifluoromethane)sulfonamide iodide), BF₄⁻, ClO₄⁻, and BOB⁻ (bis(oxalate)borate).

### BRIEF DESCRIPTION OF THE DRAWINGS

FIG. 1 depicts a sectional view of a generalized lithium ion battery assembly.

FIG. 2 is a graph depicting viscosity of ionic liquid P2221o1TFSI (Example 1) at the indicated concentrations and temperatures. Concentrations refer to LiTFSI (lithium bis(trifluoromethane)sulfonamide iodide).

FIG. 3 is a graph depicting conductivity of ionic liquid P2221o1TFSI (Example 1) at the indicated concentrations and temperatures. Concentrations refer to LiTFSI.

FIG. 4 is a graph depicting electrochemical stability of ionic liquid P2221o1TFSI (Example 1) against LMO/LTO (lithium manganese oxide/lithium titanium oxide).

FIG. 5 is a graph depicting battery cycling at C/20 (each cycle=full charge over 10 hours and full discharge over 10 hours). Triangles, % efficiency; circles, capacity; the capacity measurements on the discharge portion of the cycle are higher than the capacity measurements on the charge portion.

FIG. 6 is a graph depicting battery cycling at C/5 (each cycle=full charge over 2.5 hours and full discharge over 2.5 hours). Triangles, % efficiency; circles, capacity; the capacity measurements on the discharge portion of the cycle are higher than the capacity measurements on the charge portion.

FIG. 7A depicts chemical structures of examples of phosphonium alkyl ether ionic liquids which can be paired with any of various anions.

FIG. 7B depicts chemical structures of examples of phosphonium alkyl ionic liquid which can be paired with any of various anions.

FIG. 8A depicts chemical structures of examples of piperidinium alkyl ether ionic liquids which can be paired with any of various anions.

FIG. 8B depicts chemical structures of examples of piperidinium alkyl ionic liquid which can be paired with any of various anions.

FIG. 9A depicts chemical structures of examples of morpholinium alkyl ether ionic liquids which can be paired with any of various anions.

FIG. 9B depicts chemical structures of examples of morpholinium alkyl ionic liquid which can be paired with any of various anions.

### DETAILED DESCRIPTION OF THE INVENTION

The strong ionic interactions within ionic liquids result in non-flammable materials with negligible vapor pressure and high thermal, mechanical, and electrochemical stability. Therefore, ionic liquids have found a wide range of use as “green” solvents, fuel cells, batteries, separation media, liquid crystals, and thermal fluids.

Imidazolium-, pyrrolidinium-, piperidinium-, and ammonium-based ionic liquids have been studied for ambient applications. For example, imidazolium ionic liquids were extensively studied in the early stage because of their extraordinary ionic conductivity (>6 mS/cm), which is comparable to carbonate solvents. However, they were later reported to have poor compatibility with lithium metal, leading to high cathodic potential and narrow electrochemical window. Pyrrolidiniums generally have lower conductivities but better stability, which therefore have been studied as the replacement electrolyte for room temperature batteries, but again these have limitations and, thus, have not been commercialized. Phosphonium ionic liquids have been far less studied. Compared to imidazoliums and pyrrolidiniums, they have lower ionic conductivities at room temperature, but they possess high thermal and electrochemical stability.

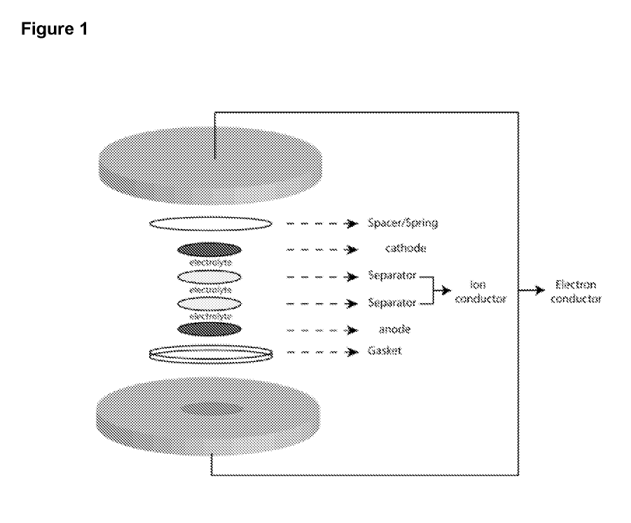

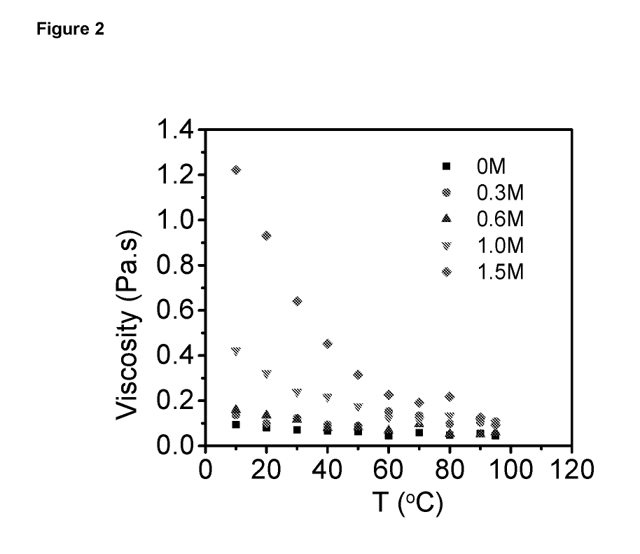

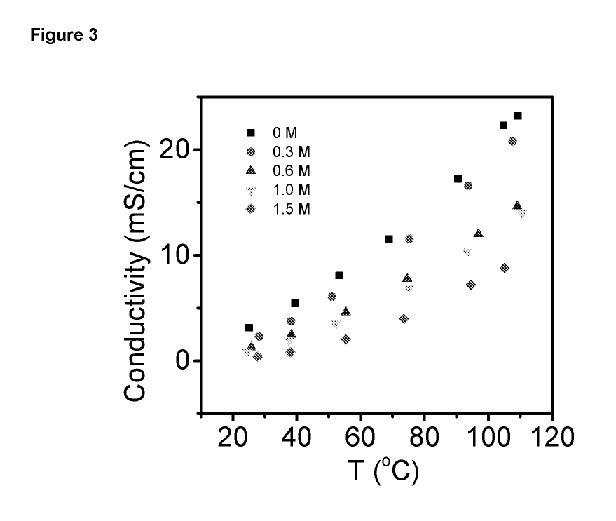

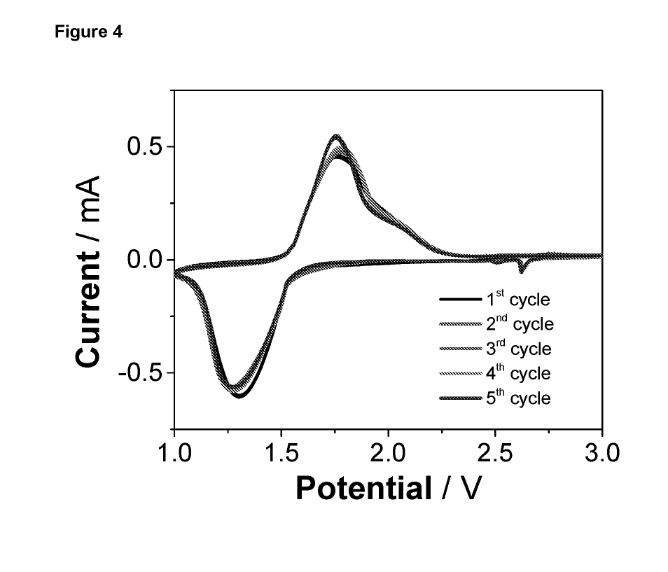

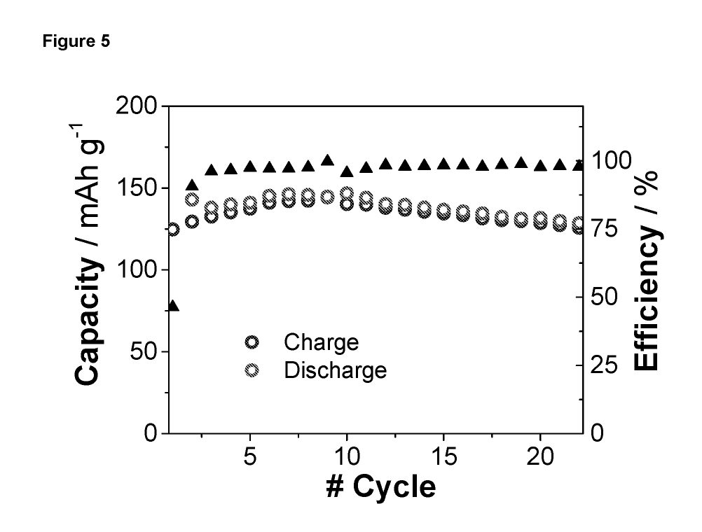

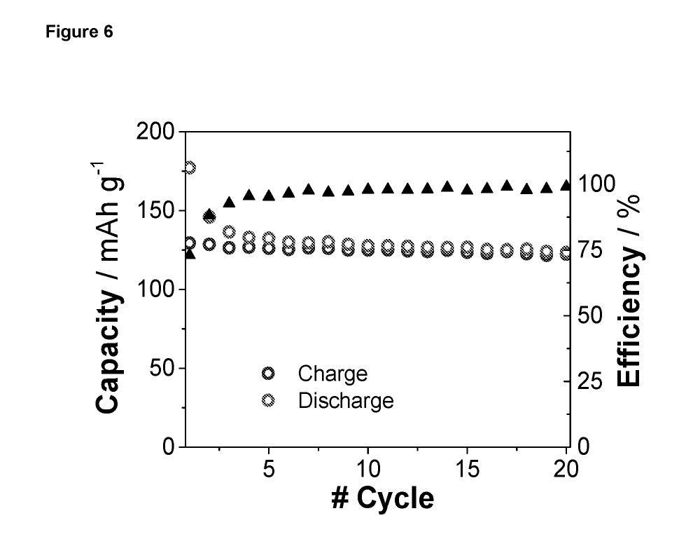

Referring to FIG. 1, a lithium ion battery comprises an anode, a cathode, a separator between the cathode and anode, and an electrolyte with a Li salt added. All of these components are packed in a cell. The illustrated cell is a coin type cell, but the invention is not limited to coin cells. Other configurations are also included such as pouch cells, cylindrical cells, or polymer cells. The invention will be, for convenience, described with regard to a coin cell with a lithium metal anode and a lithium cobalt oxide cathode, but it is not limited to that specific composition and may find use in other energy storage systems, for example, combined cells and capacitors, or other configurations.

The anode may be constructed from a lithium metal foil or a lithium alloy foil (e.g., lithium aluminum alloys), or a mixture of a lithium metal and/or lithium alloy and materials such as carbon (e.g., graphite), nickel, and copper. The anode need not be made solely from intercalation compounds containing lithium or insertion compounds containing lithium.

The cathode may be any compound compatible with the anode, electrolyte, and, if present, an intercalation compound. Suitable intercalation compounds include, for example, LiCoO₂, LiFePO₄, MoS₂, FeS₂, MnO₂, TiS₂, NbSe₃, LiNiO₂, LiMn₂O₄, V₆O₁₃, V₂O₅, and CuCl₂.

The separator is a membrane that, at least, blocks contact between the cathode and the anode. Suitable separators include polymeric microporous materials such as, but not limited to, polyethylene (PE), polypropylene (PP), polyethylene oxide (PEO), polyvinylidenefluoride (PVDF), polytetrafluoroethylene (PTFE), polyurethane, polyacrylonitrile (PAN), polymethylmethacrylate (PMMA), polytetraethylene glycol diacrylate, copolymers thereof, and mixtures thereof. Suitable separators may also be ceramic materials including, but not limited to, silicon dioxide (SiO₂), aluminum oxide (Al₂O₃), calcium carbonate (CaCO₃), titanium dioxide (TiO₂), SiS₂, SiPO₄, and mixtures thereof.

In certain embodiments, the electrolyte comprises an ionic liquid and a salt. In certain such embodiments, the ionic liquid is a phosphonium ionic liquid. In certain such embodiments, the ionic liquid is a piperidinium ionic liquid. In certain such embodiments, the ionic liquid is a morpholinium ionic liquid.

In certain embodiments, the electrolyte consists of an ionic liquid and a salt. In certain such embodiments, the ionic liquid is a phosphonium ionic liquid. In certain such embodiments, the ionic liquid is a piperidinium ionic liquid. In certain such embodiments, the ionic liquid is a morpholinium ionic liquid.

In certain embodiments, the electrolyte comprises a plurality of ionic liquids and a salt.

In certain embodiments, the electrolyte comprises an ionic liquid and a plurality of salts.

In certain embodiments, the electrolyte comprises a plurality of ionic liquids and a plurality of salts.

In certain embodiments, the electrolyte consists of a plurality of ionic liquids and a salt.

In certain embodiments, the electrolyte consists of an ionic liquid and a plurality of salts.

In certain embodiments, the electrolyte consists of a plurality of ionic liquids and a plurality of salts.

The salt may be a lithium salt. The lithium salt may include, for example, LiPF₆, LiAsF₆, LiCF₃SO₃, LiTFSI, LiBF₄, LiClO₄, LiBOB, and combinations thereof. The concentration of the salt may be varied from about 0.001 M to about 1.6 M.

The ionic liquid consists of a cation and an anion. By way of example, the phosphonium cation ionic liquid electrolyte is described due to its remarkable thermal and electrochemical stability. The lengths of the alkyl chains surrounding the phosphonium cation independently range from 2 carbons to 12 carbons in different embodiments. The lengths of the heteroalkyl chains, e.g., alkyl ether, surrounding the phosphonium cation independently range from 2 carbons to 12 combined chain carbons and chain heteroatoms in different embodiments.

As used herein, the term “heteroatom” refers to a non-carbon atom selected from the group consisting of N, O, S, Si, and P. In certain embodiments, the term “heteroatom” refers to a non-carbon atom selected from the group consisting of N, O, S, and Si. In certain embodiments, the term “heteroatom” refers to a non-carbon atom selected from the group consisting of N, O, and S.

In certain embodiments, the cation comprises one phosphonium center. In certain other embodiments, the cation comprises more than one phosphonium center. For example, in certain embodiments, the cation comprises two phosphonium centers. In one embodiment, the cation comprises two phosphonium centers linked by an alkyl ether.

In certain embodiments, the counter anion is inorganic. In certain other embodiments, the counter anion is organic. In certain embodiments, the counter anion is the same as that in the lithium salt. In certain other embodiments, the counter anion is different from that in the lithium salt.

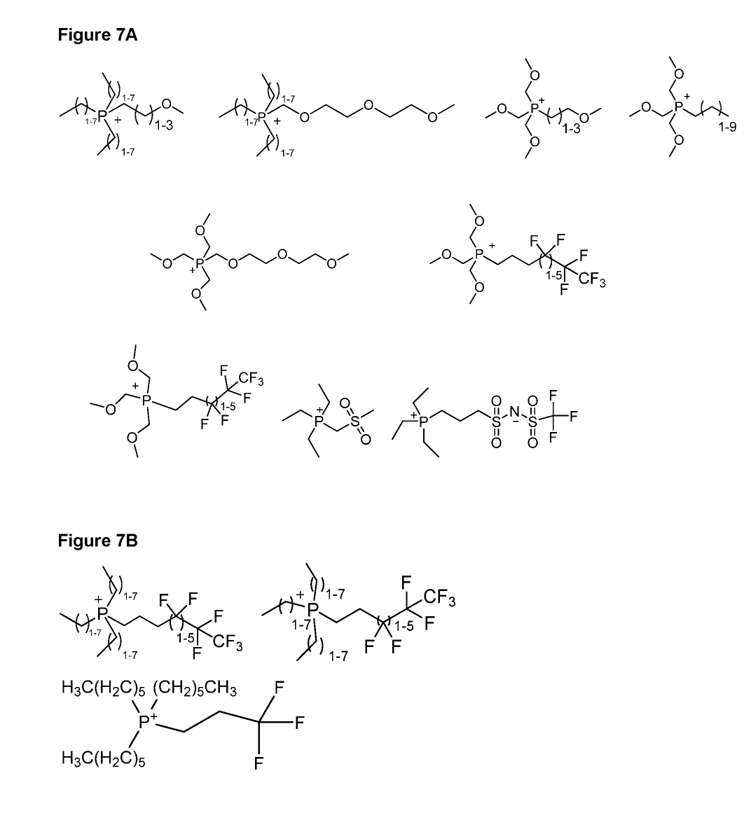

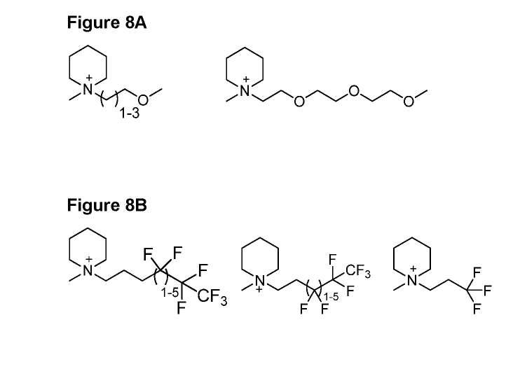

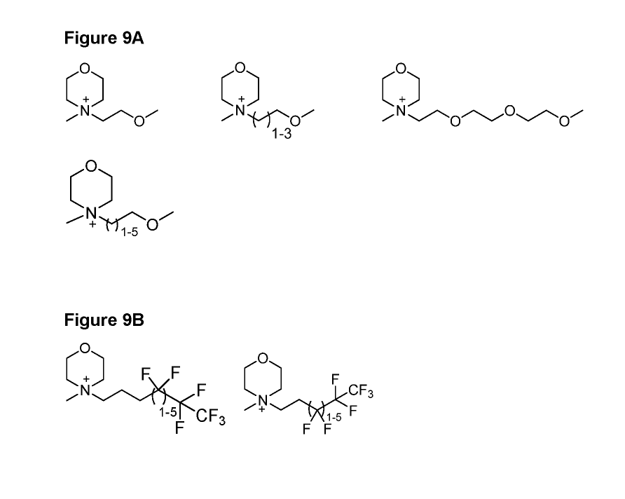

Embodiments of the present invention include phosphonium cations, piperidinium cations, and morpholinium cations with alkyl-, alkyl ether-, alkyl sulfoxide-, alkyl sulfonamide-, and alkyl sulfonamide-substituents, as well as combinations of these substituents, as disclosed herein, for example in FIGS. 7A-9B. The various cations can be paired with anions including PF₆⁻, AsF₆⁻, CF₃SO₃⁻, TFSI⁻, BF₄⁻, ClO₄⁻, BOB⁻, etc.

In certain embodiments, the ionic liquid cation is not

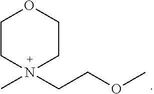

An aspect of the invention is a Li ion battery comprising an anode, a cathode, a separator, and a composition of the invention, where the Li salt is present at a concentration of at least 1.0 M.

In certain embodiments, the battery performs at temperatures greater than or equal to about 100° C.

The term “performs” as used herein with reference to a battery or supercapacitor refers to the property of said battery or supercapacitor of being capable of undergoing a number of cycles of charging and discharging. In certain embodiments, the number of cycles is at least 5. In certain embodiments, the number of cycles is at least 50. In certain embodiments, the number of cycles is at least 100. In certain embodiments, the number of cycles is at least 500. In certain embodiments, the number of cycles is at least 1000. In certain embodiments, the number of cycles is at least 5000. In certain embodiments, the number of cycles is at least 10,000. In certain embodiments, the number of cycles is at least 50,000.

A supercapacitor (sometimes ultracapacitor, formerly electric double-layer capacitor (EDLC)) is a high-capacity electrochemical capacitor with capacitance values greater than 1,000 farads at 1.2 volt that bridge the gap between electrolytic capacitors and rechargeable batteries. They typically store 10 to 100 times more energy per unit volume or mass than electrolytic capacitors, can accept and deliver charge much faster than batteries, and tolerate many more charge and discharge cycles than rechargeable batteries. They are however 10 times larger than conventional batteries for a given charge.

Supercapacitors are used in applications requiring many rapid charge/discharge cycles rather than long-term compact energy storage: within cars, buses, trains, cranes and elevators, where they are used for regenerative braking, short-term energy storage or burst-mode power delivery. Smaller units are used as memory backup for static random-access memory (SRAM).

Supercapacitors do not have a conventional solid dielectric. They use electrostatic double-layer capacitance or electrochemical pseudocapacitance or a combination of both instead.

Electrostatic double-layer capacitors use carbon electrodes or derivatives with much higher electrostatic double-layer capacitance than electrochemical pseudocapacitance, achieving separation of charge in a Helmholtz double layer at the interface between the surface of a conductive electrode and an electrolyte. The separation of charge is of the order of a few angstroms (0.3-0.8 nm), much smaller than in a conventional capacitor.

Electrochemical pseudocapacitors use metal oxide or conducting polymer electrodes with a high amount of electrochemical pseudocapacitance. Pseudocapacitance is achieved by Faradaic electron charge-transfer with redox reactions, intercalation or electrosorption.

Hybrid capacitors, such as the lithium-ion capacitor, use electrodes with differing characteristics: one exhibiting mostly electrostatic capacitance and the other mostly electrochemical capacitance.

Having now described the present invention in detail, the same will be more clearly understood by reference to the following examples, which are included herewith for purposes of illustration only and are not intended to be limiting of the invention.

### EXAMPLES

### Example 1:—Synthesis of P2221o1TFSI

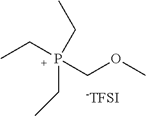

Bromomethyl methyl ether (4.5 g, 36.3 mmol) was added dropwise to 1.0 M Triethylphosphine in THF (33.0 mL, 33.0 mmol) with N₂ protection at 0° C. The resulting mixture was stirred at room temperature for 24 hours. Removal of the solvent under reduced pressure afforded the intermediate P2221o1Br. Next, P2221o1TFSI (8.0 g, 33.0 mmol) was dissolved in 20 mL of dimethylchloride. Lithium Bis(trifluoromethane)sulfonimide (11.3 g, 42.9 mmol) was dissolved in 15 mL of water and added to the PP1o2Br solution. The reaction mixture was stirred for 24 hours at room temperature. The product was washed by 3×15 mL of brine and a clear yellow liquid was obtained in 99% yield. ¹H NMR (CDCl₃): δ 1.50-1.62 (t, 9, CH₃); 1.99-2.12 (m, 6, CH₂); 3.30 (br, 3, CH₂—O); 4.10 (br, 2, CH₂—P). ES MS: 163.1 m/z [MTFSI]⁻ (theory: 163.1 m/z [M]⁺).

Following the above procedure, a series of dicationic phosphonium molecules have been prepared. All of the compounds were characterized by ¹H, ¹³C, and ³¹P NMR, and were shown to be pure by elemental analysis.

### Example 2:—Synthesis of PP1o2TFSI

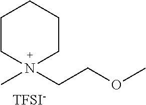

1-methylpiperidine (3.3 g, 33.6 mmol) was dissolved in 25 mL acetonitrile. 2-bromoethyl methyl ether (5.1 g, 36.9 mmol) was added dropwise at 0° C. to the solution. The resulting mixture was stirred for 24 hours at 30° C. Removal of the solvent under reduced pressure afforded the intermediate PP1o2Br. Next, PP1o2Br (8.0 g, 33.6 mmol) was dissolved in 20 mL of dimethylchloride. Lithium Bis(trifluoromethane)sulfonimide (12.5 g, 43.7 mmol) was dissolved in 15 mL of water and added to the PP1o2Br solution. The reaction mixture was stirred for 24 hours at room temperature. The product was washed by 3×15 mL of brine and a clear red liquid was obtained in 99% yield. ¹H NMR (CDCl₃): δ 1.45 (m, 2, CH₂—CH₂—CH₂); 1.60-1.65 (m, 4, N—CH₂—CH₂—CH₂); 2.83 (s, 3, CH₃—O); 3.08 (s, 3, CH₃—N); 3.10 (m, 2, CH2-CH₂—O); 3.18-3.22 (m, 2, N—CH₂—CH₂); 3.33 (m, 2, N—CH₂—CH₂); 3.50 (m, 2, N—CH₂—CH₂). ES MS: 158.1 m/z [MTFSI]⁻ (theory: 158.1 m/z [M]⁺).

### Example 3:—Synthesis of 1,1,1-triethyl-3,3,3-trifluoropropyl phosphonium iodide (P2223F3I) and 1,1,1-triethyl-1-methoxyethoxyethyl phosphonium bromide (P2225O2Br)

1,1,1-triethyl-3,3,3-trifluoropropyl phosphonium Iodine (P2223F3I) and 1,1,1-triethyl-1-methoxyethoxyethyl phosphonium bromide (P2225O2Br) were synthesized as shown in the scheme below.

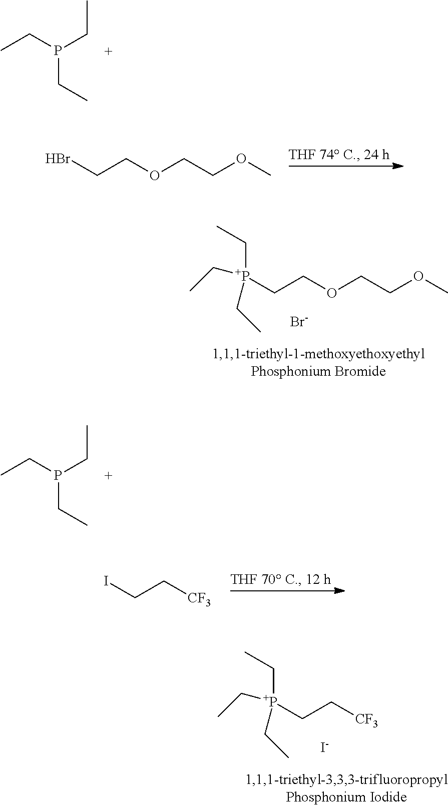

The yield for each ionic liquid was over 90%. The structures were confirmed using liquid chromatography/mass spectroscopy and ¹H, ¹³C, and ³¹P NMR.

P2223F3I was purified using flash chromatography. P2223F3I is a solid compound. Replacing the anion to form 1,1,1-triethyl-3,3,3-trifluoropropyl phosphonium TFSI (P2223F3TFSI) also produced a solid. Subsequent analysis via differential scanning calorimetry (DSC) showed that P2223F3I melts at approximately 98° C.

P2225O2Br was purified using flash chromatography and is a liquid at room temperature and at 100° C. 1,1,1-triethyl-1-methoxyethoxyethyl phosphonium TFSI (P2225O2TFSI) was also prepared, and was a liquid.

### INCORPORATION BY REFERENCE

All patents and published patent applications mentioned in the description above are incorporated by reference herein in their entirety.

### EQUIVALENTS

Having now fully described the present invention in some detail by way of illustration and example for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

1. An ionic liquid electrolyte, comprising a cation represented by 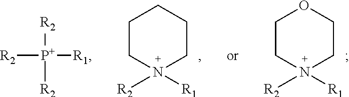
a counter anion; and
a lithium salt;
wherein independently for each occurrence
R₁ is selected from the group consisting of 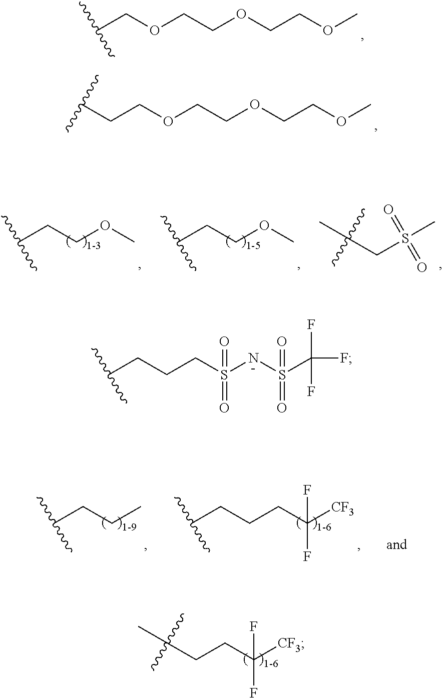
R₂ is selected from the group consisting of

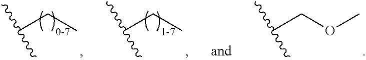

2-3. (canceled)

4. The ionic liquid electrolyte of claim 1, wherein:
the cation is represented by 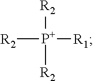
and
R₁ is

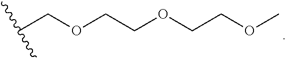 [SMILES: *COCCOCCOC]

5. The ionic liquid electrolyte of claim 1, wherein:
the cation is represented by 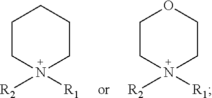
and
R₁ is

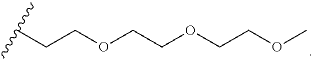 [SMILES: *CCOCCOCCOC]

6. The ionic liquid electrolyte of claim 1, wherein R₁ is

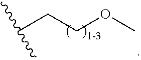

7. The ionic liquid electrolyte of claim 1, wherein R₁ is

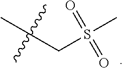 [SMILES: *CS(C)(=O)=O]

8. The ionic liquid electrolyte of claim 1, wherein R₁ is

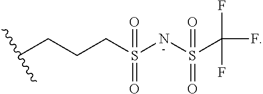 [SMILES: *CCCS(=O)(=O)NS(=O)(=O)C(F)(F)F]

9. The ionic liquid electrolyte of claim 1, wherein R₁ is

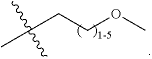

10. The ionic liquid electrolyte of claim 1, wherein:
the cation is represented by 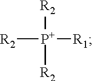
and
R₁ is

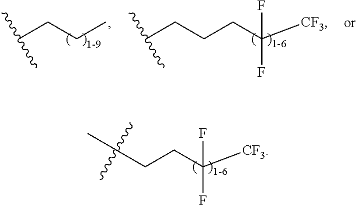

11-12. (canceled)

13. The ionic liquid electrolyte of claim 1, wherein:
the cation is represented by 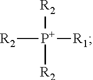
and
R₂ is

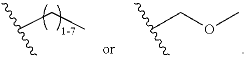

14. (canceled)

15. The ionic liquid electrolyte of claim 1, wherein:
the cation is represented by 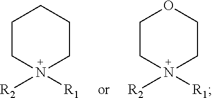
and
R₂ is methyl.

16. The ionic liquid electrolyte of claim 1, wherein the counter anion is selected from the group consisting of PF₆⁻, AsF₆⁻, CF₃SO₃⁻, TFSI⁻, BF₄⁻, ClO₄⁻, and BOB⁻.

17. The ionic liquid electrolyte of claim 1, wherein the lithium salt is selected from the group consisting of LiPF₆, LiAsF₆, LiCF₃SO₃, LiTFSI, LiBF₄, LiClO₄, and LiBOB.

18. A Li ion battery comprising an anode, a cathode, a separator, and the ionic liquid electrolyte of claim 1, wherein the Li salt is present at a concentration of at least 1.0 M.

19-20. (canceled)

21. The Li ion battery of claim 18, wherein the battery performs at temperatures greater than or equal to about 100° C.

22-24. (canceled)

25. A Li ion battery of claim 18, wherein the battery performs for more than 30 cycles.

26. A supercapacitor comprising the ionic liquid electrolyte of claim 1, where the Li salt is present at a concentration of at least 1.0 M.

27-28. (canceled)

29. The supercapacitor of claim 26, wherein the supercapacitor performs at temperatures greater than or equal to about 100° C.

30-33. (canceled)

34. The ionic liquid of claim 1, comprising a cation selected from the group consisting of 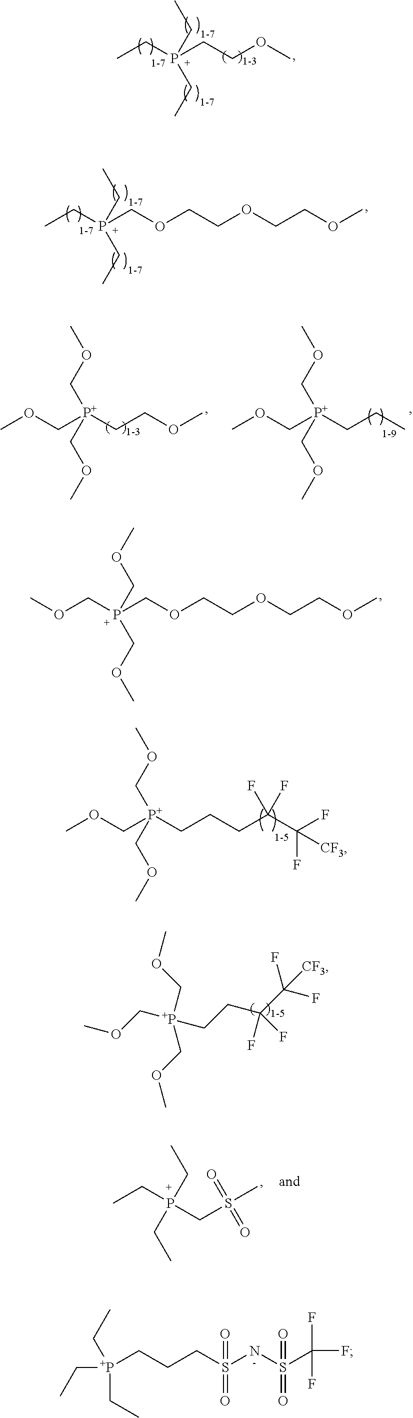
and
a counter anion.

35. The ionic liquid of claim 1, comprising a cation selected from the group consisting of 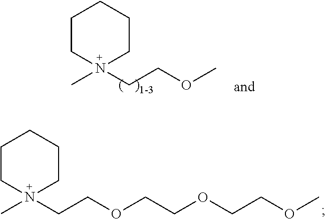
and a counter anion.

36. (canceled)

37. The ionic liquid of claim 1, comprising a cation selected from the group consisting of 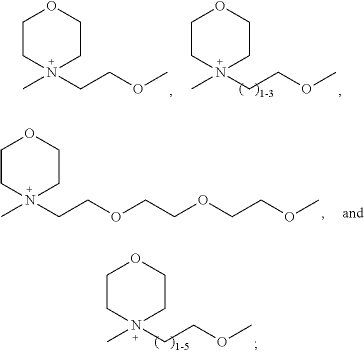
and a counter anion.

38. (canceled)
